(19) United States
(12) Patent Application Publication
(10) Pub. No.: US 2005/0151459 A1
(43) Pub. Date: Jul. 14, 2005

(54) Luminescent screen

(76) Inventors: Leonie Maria Geerdinck, Eindhoven (NL); Esther De Beer, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,804

(22) PCT Filed: Apr. 22, 2003
(86) PCT No.: PCT/IB03/01588

(30) Foreign Application Priority Data
Apr. 22, 2002 (EP) 02076560.8

(51) Int. Cl. H01J 63/04; H01J 1/62

(52) U.S. Cl. 313/485; 313/486; 313/489; 313/635

(57) ABSTRACT

In a fluorescent lamp mercury consumption is reduced by embedding the luminescent particles making up the luminescent layer in a matrix of aluminum phosphate comprising aluminum oxide particles and covering the embedded luminescent particles with a top coating of e.g. yttrium oxide.

The invention relates to a luminescent screen comprising particles of luminescent material embedded in an inorganic material. The invention also relates to a discharge lamp comprising such a luminescent screen.

A luminescent screen as mentioned in the opening paragraph is known from U.S. Pat. No. 5,808,407. The known luminescent screen is part of a fluorescent lamp. In a fluorescent lamp in which the particles of luminescent material are not embedded in an inorganic layer, mercury present in the lamp vessel interacts with the luminescent materials. This leads to a depreciation of the properties of the luminescent materials. Additionally mercury disappears from the discharge into the luminescent materials during the life of the fluorescent lamp. This mercury consumption has to be accounted for when the lamp is manufactured by including more mercury in the lamp vessel than would have been necessary if the mercury consumption were absent. This is undesirable from an environmental point of view. In the past attempts have been made to reduce the mercury consumption by coating the particles of luminescent material with a coating that does not interact strongly with mercury. Alternatively a coating of such a material has been applied to the whole luminescent screen. Although both these measures reduce the mercury consumption to some extent, a relatively high mercury consumption still remains because the surface are of the luminescent screen remains very high. This high surface area is caused by the pores existing between the individual luminescent particles. The problem of the high surface area can be overcome by embedding the particles of luminescent material in an inorganic material as described in U.S. Pat. No. 5,808,407. Since the inorganic material fills up the pores between the luminescent particles the remaining surface area becomes very small so that only a small amount of interaction between the luminescent screen and mercury can take place. The inorganic material that is used for the embedding in U.S. Pat. No. 5,808,407 is an aluminosilicate. A serious drawback of this material is that cracks form in the surface of the luminescent screen, when the luminescent screen is thicker than a few μm. These cracks cause an increase in the surface area of the luminescent screen and also cause the surface of luminescent particles to be exposed to interaction with mercury, so that the known luminescent screen does no longer provide a very low mercury consumption when its thickness is higher than approximately 1 μm. However, to make sure that virtually all of the UV radiation that is generated in the discharge is absorbed by the luminescent particles, it is desirable to form a luminescent screen with a thickness that equals several times the average diameter of the luminescent particles. Since in practice the diameter of luminescent particles is often in the order of magnitude of a μm, this requires the luminescent screen to have a thickness of at least several μm.

The invention aims to provide a luminescent screen in which the luminescent particles are embedded, that has a very low virtually crackfree surface area even when the luminescent screen has a comparatively high thickness.

A luminescent screen as mentioned in the opening paragraph is therefor characterized in that the inorganic material comprises aluminium phosphate.

It has been found that comparatively thick crackfree luminescent screens could be formed making use of aluminium phosphate.

It was also found that even thicker crackfree luminescent screens could be obtained in case the inorganic material further comprises particles of an inorganic oxide oxide preferably aluminium oxide or silicon oxide. The particles function as a filler material. In order to realize a good filling of the pores between the luminescent particles it is essential that the average diameter of the metal oxide particles is much smaller than the average diameter of the luminescent particles. In practice it was found that when the average diameter of the luminescent particles is several μm, the average diameter of the metal oxide particles is preferably several nm.

A luminescent screen according to the invention is very suitable for use in a discharge lamp, more in particular a fluorescent lamp, for reasons pointed out hereabove. Such a discharge lamp usually comprises a lamp vessel that is transparant for visible light and the luminescent screen is preferably deposited on part of an inner wall of the lamp vessel. A luminescent screen according to the invention can also be deposited on part of an outer wall of the lamp vessel.

It has been found that although the surface area of a luminescent screen according to the invention is relatively small a further decrease in mercury consumption can be realized by covering the luminescent screen with a top layer. This top layer should be formed out of a material that has a comparatively small interaction with mercury. Good results have been obtained for top layers comprising a compound that is chosen from the group formed by yttrium oxide, yttrium-strontium borate and aluminium oxide.

Fluorescent lamps according to the invention can for instance be manufactured by mixing luminescent particles and aluminium oxide particles in water with mono aluminium phosphate and applying the resulting slurry to the wall of a lamp vessel using techniques that are well known in the art. The lamp is subsequently dried at a temperature of approximately 100C and heated in air at a temperature in the range 300C-400C so that an aluminium phosphate matrix is formed containing the aluminium oxide particles and the luminescent particles. Alternatively a luminescent layer only comprising the luminescent particles can be applied to the wall of a lamp vessel making use of application techniques well known in the art. Subsequently a slurry comprising aluminium oxide (or silicon oxide) and mono aluminium phosphate is brought into contact with the luminescent layer. This way the pores between the luminescent particles become filled with this slurry and the slurry also covers the surface of the luminescent layer. The lamp is subsequently dried and heated in air. A top coating of for instance yttrium oxide can also be applied by covering the luminescent screen with a solution of yttrium acetate, drying and heating at a temperature in the range 500° C.-600° C.

1. A luminescent screen comprising particles of luminescent material embedded in an inorganic material, characterized in that the inorganic material comprises aluminium phosphate.

2. A luminescent screen as claimed in claim 1, wherein the inorganic material further comprises particles of an inorganic oxide.

3. A luminescent screen as claimed in claim 2, wherein the inorganic oxide comprises a compound chosen from the group formed by aluminium oxide and silicon oxide.

4. A discharge lamp equipped with a luminescent screen as claimed in claim 1.

5. A discharge lamp as claimed in claim 4, wherein the discharge lamp comprises a lamp vessel that is transparant for visible light and the luminescent layer is deposited on part of an inner wall or part of an outer wall of the lamp vessel.

6. A discharge lamp as claimed in claim 5, wherein the luminescent screen is covered by a top layer.

7. A discharge lamp as claimed in claim 6, wherein the top layer comprises a compound chosen from the group formed by yttrium oxide, yttrium-strontium-borate and aluminium oxide.

8. A discharge lamp as claimed in claim 4, wherein the discharge lamp is a fluorescent lamp.
